(19) United States
(12) Patent Application Publication
(10) Pub. No.: US 2011/0061988 A1
(43) Pub. Date: Mar. 17, 2011

(54) IMPROVEMENTS RELATING TO BANKNOTE VALIDATION

(76) Inventor: Peter Lonsdale, Oldham (GB)

(21) Appl. No.: 11/814,638

(22) PCT Filed: Jan. 25, 2006
(86) PCT No.: PCT/GB06/00257

§ 371 Date: Dec. 23, 2009

(30) Foreign Application Priority Data
Jan. 25, 2005 (GB) 0501568.0

(51) Int. Cl. G07D 7/12

(52) U.S. Cl. 194/303

(57) ABSTRACT

A banknote validation arranged to discriminate between real and false banknotes is described. The valuator comprises: a light source arranged to emit light in the non-visible spectrum onto a banknote being validated, the emitted light including an ultraviolet (1O nm to 400 nm) or intra red (800 run-1 00000 nm) wavelength of light; a broadband optical light sensor arranged to sense a relatively broad band of visible light spectrum wavelengths of light emitted by fluorescence from the banknote in response to the banknote being irradiated with the non-visible spectrum wavelengths of light; and an optical filter positioned between the banknote and the sensor and arranged to prevent illumination of the sensor with reflected or transmitted non-fluoresced light from the light source, the optical filter having a −3 db cut off point selected such that the light emitted from the light source, having a wavelength closest to the visible light spectrum wavelengths of light, is filtered.

### FIELD OF THE INVENTION

The present invention concerns improvements relating to banknote validation and in particular, though not exclusively, to an improved method of and apparatus for sensing optical characteristics of a banknote in order to determine its authenticity. It is to be appreciated that the term ‘banknote’ as used herein is to be considered refer to any manufactured item provided on a special paper-like substrate and having a value, such as a ticket, voucher or currency note, the substrate having fluorescence characteristics.

### BACKGROUND OF THE INVENTION

Automatic recognition (validation) of banknotes is well known, (see for example European patent application EP 0 738 408 to Mars Inc.) and many of the techniques used to discriminate real and false banknotes are well documented. Historically, such automatic banknote validators require a set of several different types of sensors (and associated radiation sources) that each measure a different physical parameter of the banknote, e.g. optical, magnetic, density characteristic etc, to discriminate between an extensive range of real and false banknotes reliably. This is for example seen in international patent application WO 03/063098 (Eurosystems Limited). This produces a set of different results, which can be compared to that expected for a valid banknote to determine whether the banknote is considered to be valid in respect of the current testing location.

Typically, each banknote needs to be tested at several locations in order to be verified as an authentic banknote. Accordingly, in many cases the banknote is moved with respect to the sensors such that different locations on the surface of the banknote can be tested by the set of different sensors. Quite often two or more sets of different sensors, displaced with respect to the direction of the banknote path through the validator and each other, are provided. This ensures that different locations across the width of the banknote are also tested to avoid common fraud. A valid banknote is one, which passes these tests at all sampled locations. The results from all of the sets of different sensors represent a massive amount of data.

A further issue with the previous sensor arrangements including sources, radiation guides, sensors and signal processing means is the relatively high cost. Not only does providing these pluralities of different sensors increase the cost of the banknote validator, but also the processing and storage of the vast amounts of generated and stored comparison data also requires more processing power and memory in the banknote validator.

It is also known to irradiate banknotes with ultraviolet light and to measure a specific fluoresced wavelength of light, commonly known as a ‘blue’ fluorescence response. It is known that this fluorescence occurs in the majority of counterfeit currency; genuine banknotes don't fluoresce in this way. This blue fluorescence comes from dyes (such as OBA—Optical Brightener Agent) in plain paper designed to make it appear whiter by fluorescing blue, these dyes are not used in banknotes. The same dyes are used in washing powder to make clothes look whiter, which is why if a genuine banknote is accidentally washed, it will glow blue under UV and probably be mistaken as a fake by shopkeepers with UV light testers.

Typically, such banknote sensing arrangements, see for example European patent application EP 0 738 408 to Mars Inc., incorporate a narrow band-pass filter designed around this ‘blue’ fluorescence wavelength. All other visible wavelengths of light are filtered out to prevent potential stray light problems for example, and to maximise the signal to noise ratio (S/N) of the ‘blue’ fluorescence response. A further sensor is also provided to sense the reflected non-visible ultraviolet light too and this uses another band pass filter that filters out fluoresced light. The use of such specific wavelength narrow band-pass filters is considered necessary but is relatively expensive. Alternatively, a filter does not have to be used at all and sensors having a narrow band-pass sensitivity characteristic could be used also having a peak response based around the desired sensed wavelength. Such narrow band sensors are even more expensive than the narrow band-pass filters mentioned above.

### SUMMARY OF THE PRESENT INVENTION

The present invention seeks to overcome or reduce at least some of the above-described problems with the prior art. More particularly, the present invention desires to maintain and improve on the existing methods and validators' reliability of discriminating between real and false banknotes, whilst at the same time seeking to reduce costs of such discriminating systems.

The present invention resides in the application of a discovery made whilst experimenting on optical characteristics of banknotes. The present inventor determined that by stimulating banknotes with non-visible wavelengths of light, looking at either reflected or transmitted fluoresced characteristics of the banknote, unique banknote characterising interactions may be observed by sensing visible wavelengths of received light whilst stimulating the banknote with non-visible wavelengths of light.

More specifically, it has been found that many real banknotes have a very different behaviour than false banknotes when examined in this way. In particular, when a banknote is stimulated with non-visible ultraviolet wavelengths of light, the wavelengths of light emitted (reflected or transmitted through the banknote) at visible light wavelengths are very different for authentic and false banknotes. This florescence effect is also achievable by using non-visible infrared wavelengths of light, which show very different results in certain authentic and counterfeit substrates for lower wavelength, visible fluoresced light transmitted or reflected from the substrate.

This phenomenon is new and differs from prior art tests in that the test is not based on merely a response being obtained at a specific frequency when a false banknote is irradiated with a given wavelength of light, such as the above-described effect of ‘blue’ florescence.

The present inventor has determined that by examining the relatively wide spectrum of emitted visible light, when a genuine banknote is stimulated with non-visible wavelengths of light, including ultraviolet or infrared wavelengths of light, other less apparent visible wavelength emissions occur that are useful in discriminating real banknotes from false ones. These visible wavelength emissions contain more useful and subtle information than the above-mentioned known ‘blue’ wavelength florescence for counterfeit banknotes.

According to one aspect of the present invention there is provided a banknote validator arranged to discriminate between real and false banknotes, the validator comprising: a light source arranged to emit light in the non-visible spectrum onto a banknote being validated, the emitted light including an ultraviolet (10 nm to 400 nm) or infrared (800 nm-100000 nm) wavelength of light; a broadband light sensor arranged to sense a relatively broad band of visible light wavelengths of light emitted by fluorescence from the banknote in response to the banknote being irradiated with the non-visible wavelengths of light; and an optical filter positioned between the banknote and the sensor and arranged to prevent illumination of the sensor with reflected or transmitted non-fluoresced light from the light source, the optical filter having a selected −3 db cut-off point which at least filters the non-visible light emitted from the light source, having a wavelength closest to the visible light spectrum wavelengths of light.

The whole point of the present invention is to apply this discovery at a low cost. Whilst it would be possible to use a spectrophotometer, this is clearly too expensive as it is several orders of magnitude greater in price that the banknote validator itself. Rather, the present invention is embodied in a simple, light source, sensor and optical filter arrangement, which minimises cost. It is to be appreciated that a high-pass or a low-pass filter, namely a filter having a simple step function, is typically far cheaper than a band-pass filter. Also the present invention can be implemented with a single sensor if needs be rather than two sensors as is seen in EP 0 738 408. Furthermore, the computational overhead of validating a genuine banknote is significantly reduced as compared with the prior art devices, because a single integrated reading for each different part of the banknote to be sensed is obtained rather than multiple different readings at each banknote sensing location. Furthermore, and very importantly, the use of a broadband sensor is key to keeping the cost of the present invention low. This is because a single broadband sensor is cheaper than a narrow band sensor or multiple sensors.

As an example, if the highest relative wavelength of light being emitted from an ultraviolet light source was 300 nm, the high-pass filter (in terms of wavelength) would have to have a −3 db cut-off point of 300 nm or greater. Preferably, the cut-off point would be at least 50 nm higher (in terms of wavelength which of course, is lower in terms of frequency) than the highest relative wavelength emitted from the light source. This is considered to be an ideal offset in wavelength, which ensures that no directly reflected or transmitted light gets to the sensor.

The present invention accords with the above-mentioned desire and specifically provides a method and validator that can discriminate a very large variety of different types of false banknotes from real banknotes at a very low relative cost with a minimum number of sensors and sensor arrangements. Sensors that have a broadband sensing characteristic are a far lower cost than narrow-band sensing characteristic sensors, which helps to reduce costs. Also by simplifying the sensor arrangement, the reliability of the validator increases and the amount of data generated decreases as does, very importantly, its costs.

The present invention can also be considered to be a banknote validation method of discriminating between real and false banknotes, the method comprising: irradiating light in the non-visible spectrum onto a banknote being validated, the emitted light including an ultraviolet (10 nm to 400 nm) or infrared (800 nm-100000 nm) wavelength of light; optically filtering the light received from the banknote to obtain fluoresced light from the banknote, the optical filtering having a selected −3 db cut-off point which at least filters the non-visible light emitted from the light source, having a wavelength closest to the visible light spectrum wavelengths of light; and measuring the filtered emitted light over a relatively wide range of visible light wavelengths in response to the banknote being irradiated with the non-visible wavelengths of light in use.

According to another aspect of the present invention there is provided a banknote validator arranged to discriminate between real and false banknotes, the banknote validator comprising: a light source arranged to emit light in the non-visible spectrum onto a banknote being validated, the emitted light including an ultraviolet (10 nm to 400 nm) or infrared (800 nm-100000 nm) wavelength of light; two broadband light sensors, one positioned in use with respect to the portion of the banknote to measure the filtered reflected light and the other sensor positioned in use with respect to the portion of the banknote to measure the filtered transmitted light, each sensor being arranged to be sensitive over a relatively broad band of visible wavelengths of light emitted by fluorescence from the banknote in response to the banknote being irradiated with the non-visible wavelengths of light and to generate an output signal representative of the measured light; two high-pass filters, each high-pass filter being arranged to have a −3 db point at least closer to the visible light spectrum than the closest wavelength of light radiated from the irradiating means, one of the filters being positioned to filter the light reflected from the portion of the banknote and the other filter being positioned to filter the light transmitted through the portion of the banknote; a comparator for comparing the value of the output signal of each sensor with predetermined values that represent a valid banknote; and a determining means for determining the validity of the portion of the banknote based on the results of the comparator.

It is possible in different embodiments of the present invention to measure the light reflected from the banknote, transmitted through the banknote or both the reflected and the transmitted light.

In one embodiment of the present invention, the banknote can be first excited (irradiated with non-visible light) at low cost by using an ultraviolet emitting LED (light-emitting diode). However, by using a broadband optical receiver with in conjunction with a high-pass wavelength (low-pass frequency) optical filter, higher wavelength emissions can be detected. This can be created using a general-purpose low-cost photodiode and a low-cost conventional plastics filter. The photodiode has a broad response but the high-pass filter cuts off at 500 nm or at a point at least greater than the highest wavelength emitted from the excitation light source. The filter separates out the light that is reflected back from the banknote that does not cause any excitation from the other low-level florescence wavelengths.

The use of a single sensor also makes the task of making the comparison between a valid and a false banknote easier, because the single sensor integrates the emitted responses over a wide range of wavelengths which in turn results in a single voltage output signal being produced representing a value for that banknote location. Once several such values have been obtained they can be compared against reference values representative of a valid banknote. In the actual validation of a banknote, a whole banknote would need to be read by taking a plurality of readings at different positions with the single sensor and comparing all the results with reference voltages. Using the present embodiment, for each point on the banknote, a single integrated multiple wavelength reading is taken rather than multiple readings with different optical wavelengths. A single value for a banknote location can be used for comparison instead of the prior art method of carrying out more complex analysis on multiple results for each banknote location.

The main benefit of this system is that it provides much better recognition of real banknotes compared to false banknotes than the previously known visible ‘blue’ emission based systems. Furthermore, the present invention is also significantly lower in cost to manufacture and is simpler than other systems that necessarily require more than one sensor for measuring each of the reflected and transmitted light interactions.

### BRIEF DESCRIPTION OF THE DRAWINGS

In order that the invention may be more readily understood, reference will now be made, by way of example, to the accompanying drawings in which:

FIG. 1 is a perspective view of a two-part banknote housing of a validator incorporating a light sensing arrangement embodying the present invention;

FIG. 2 is an exploded perspective view of the upper and lower parts of the banknote validator housing shown in FIG. 1;

FIG. 3a is an exploded perspective view of the lower part of the banknote validator housing of FIG. 1 showing a lower light sensing arrangement;

FIG. 3b is an exploded perspective view of the upper part of the banknote validator housing of FIG. 1 showing an upper light sensing arrangement;

FIG. 4 is a sectional view through the banknote validator housing of FIG. 1 along the length of the validator in the direction of a banknote part;

FIG. 5 is a schematic circuit diagram showing how each sensing arrangement is positioned with respect to the banknote and the signal processing elements of the validator;

FIG. 6 is a graph of the emission characteristics of the light source used in the upper and lower sensing arrangements;

FIG. 7 is a graph showing the reception characteristics of the light sensor used in the upper and lower sensing arrangements;

FIG. 8 is a flow chart showing the operation of the sensing arrangement in determining the validity of a banknote; and

FIG. 9 is a graph of the emission characteristics of an Infrared light source used in a second embodiment of the present invention.

### DETAILED DESCRIPTION OF THE EMBODIMENTS

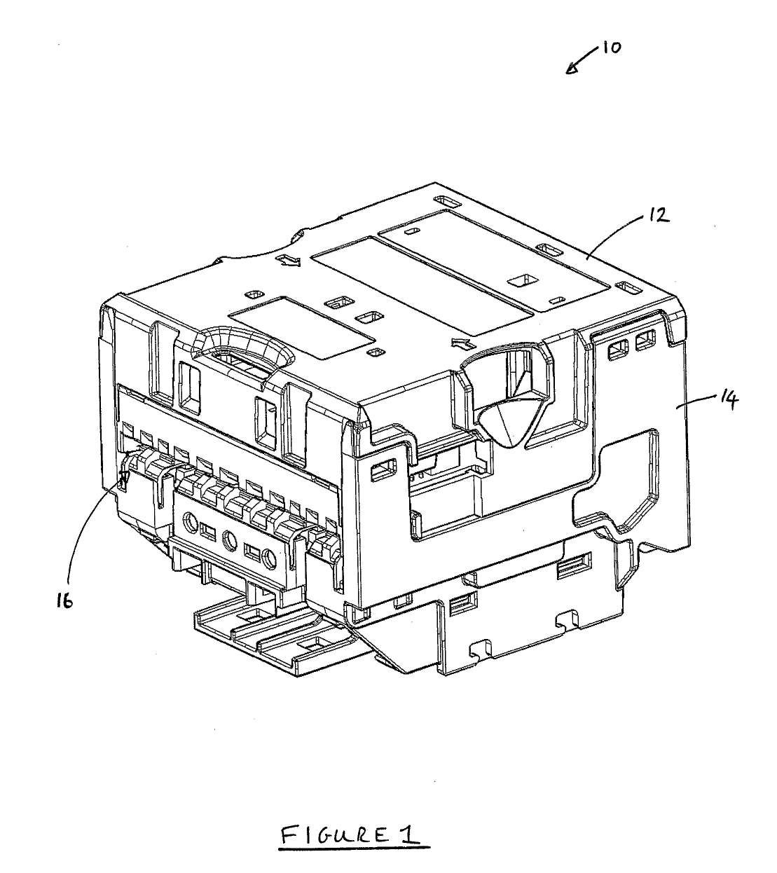

Referring to FIG. 1 there is shown a banknote validator housing 10 incorporating a sensing arrangement according to the first embodiment of the present invention. The banknote validator housing 10 comprises an upper part 12 and a lower part 14, which are arranged to releasably interlock to form the validator housing 10. When locked together, the upper and lower parts 12, 14 define a banknote validation pathway that commences at a note entrance 16. For the purposes of this invention, the banknote housing 10 represents the banknote validator. Even though all of the validator's functioning parts are not shown, the essential ones to this invention are.

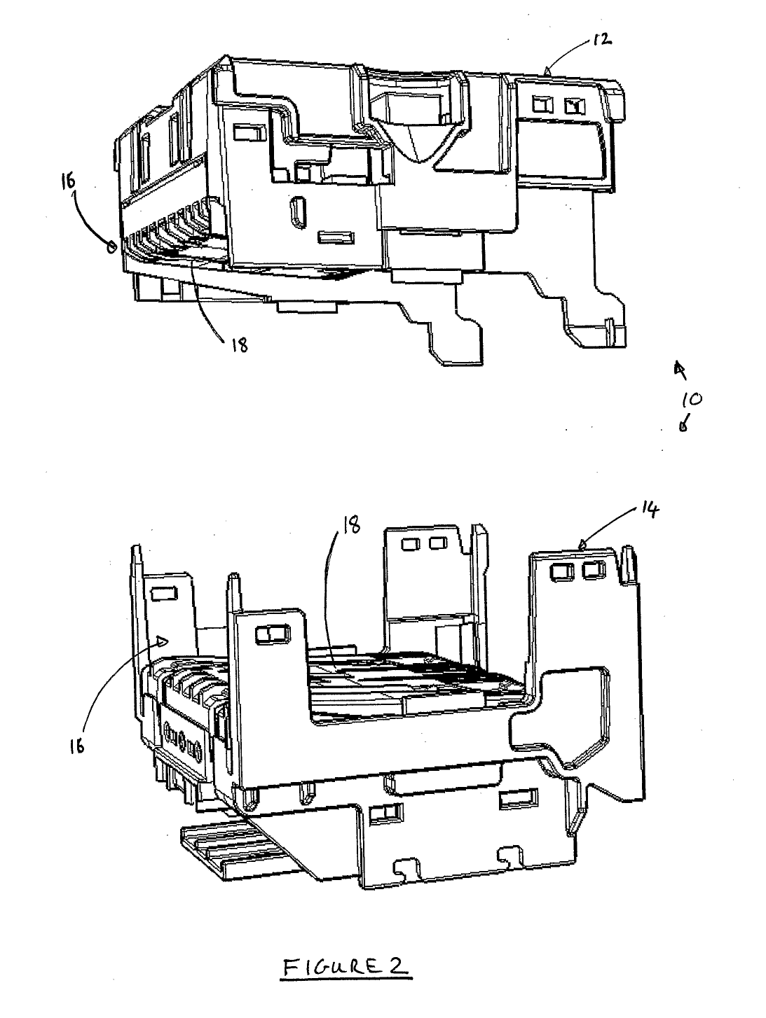

FIG. 2 shows the upper and lower parts 12, 14 of the banknote validator housing 10 in separated positions. Here the banknote validation pathway 18 can be seen on both parts 12, 14 starting at the note entrance 16.

Whilst it is possible to simply have a single sensing arrangement provided on one side of the banknote path, in this embodiment each of the lower and upper parts comprises its own dual sensing arrangements as are described in further detail below.

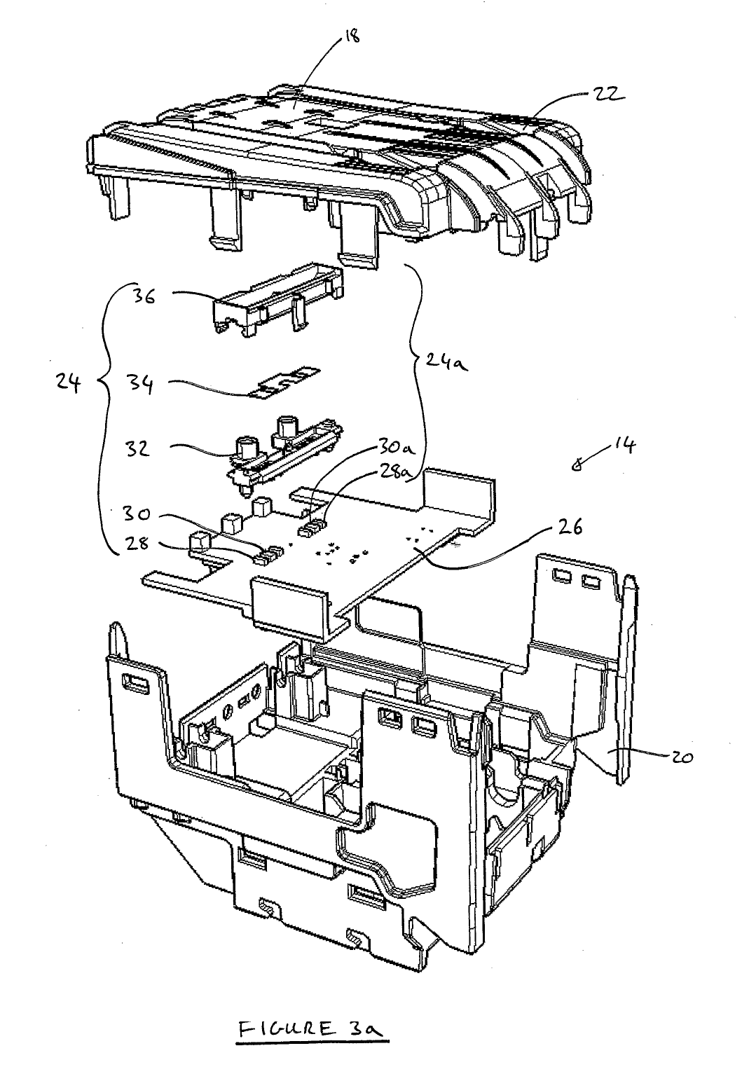

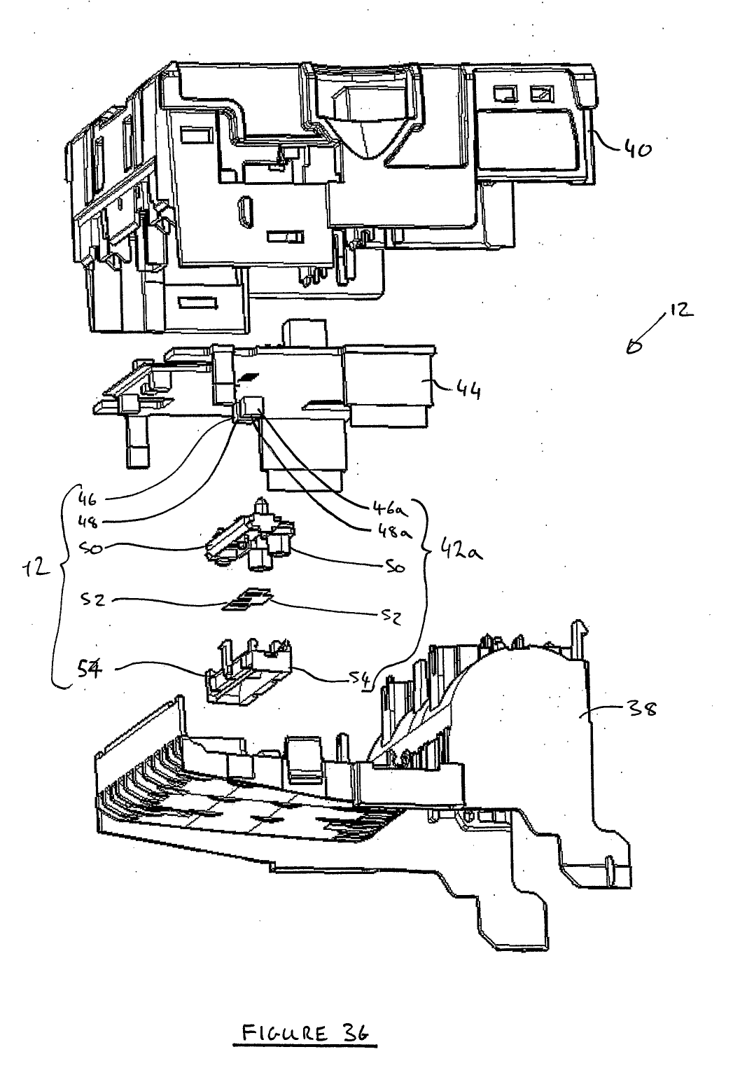

Referring now to FIG. 3a an exploded view of the lower part 14 of the banknote validator housing 10 is shown. The lower part 14 comprises a robust plastics lower case 20 and an interlocking lower lens 22 made from a transparent plastics material. Also provided is a first sensing arrangement 24 on a printed circuit board 26. The first sensing arrangement 24 comprises a UV light emitting diode (LED) 28, a photodiode 30, a first opaque lens holder 32 a plastics high (wavelength) pass filter 34 and a second opaque lens holder 36. The elements of the first sensing arrangement 24 are designed to fit together to form a compact unit, which in use, shines light onto a banknote and also senses fluoresced light, through the transparent lower lens 22.

The filter 34 is shaped so that it only covers the photodiode 30 and not the UV light emitting diode 28. The filter 34 can be made of any plastics material, as it is cheap and easy to manipulate into a desired shape. The actual type of plastics is unimportant so long as it exhibits the correct desired cut-off wavelength. In this embodiment, the plastic sheet filter is made from polyester.

In this embodiment, a second sensing arrangement 24a is provided adjacent the above-described first sensing arrangement 24. The second sensing arrangement provides a second testing location across the width of the banknote being sensed which can be useful for protection against some types of banknote counterfeiting.

The second sensing arrangement 24a comprises a second UV light emitting diode 28a and a second broadband visible light sensor 30a, which are identical to those of the first sensing arrangement 24. The second sensing arrangement 24a shares the first opaque lens holder 32, the plastics high-pass (wavelength) filter 34 and the second opaque lens holder 36 of the first sensing arrangement, these elements being physically wide enough to cover both light sources 28, 28a and sensors 30, 30a of the two arrangements 24, 24a. However, the filter 34 only covers the sensors 30, 30a and does not cover the light sources 28 and 28a.

FIG. 3b shows an exploded view of the upper part 12 of the banknote validator. The upper part houses a sensing arrangement 34, which is identical to the sensing arrangement 24 of the above-described lower part 14 of the banknote validator housing 10. The upper part 12 comprises a transparent plastics material upper lens 38 and an interlocking upper body 40. Together, the lens 38 and the body 40 house the third and fourth sensing arrangements 42, 42a. The third sensing arrangement 42 is provided on a printed circuit board 44 and comprises a UV light emitting diode 46, a photodiode 48, a first opaque lens holder 50, a plastics high (wavelength) pass filter 52 and a second opaque lens holder 54. It is to be appreciated that the UV (ultraviolet) light diode emitting 46 and the photodiode 48 are shown very close together in FIG. 3b and they are not a readily distinguishable as compared to the photodiode 30 and UV LED 28 shown in FIG. 3a. The elements of the third sensing arrangement 42 are designed to fit together to form a compact unit, which in use, shines light onto the banknote and also senses fluoresced light, through the transparent upper lens 38.

The fourth sensing arrangement 42a is provided adjacent the above described third sensing arrangement 42 and is also located on the printed circuit board 44. The fourth sensing arrangement 42a provides a second testing location across the width of the banknote being sensed which can be useful for protection against some types of banknote counterfeiting. The fourth sensing arrangement 42a shares the first opaque lens holder 50, the plastics high-pass (wavelength) filter 52 and the second opaque lens holder 54 of the third sensing arrangement, these elements being physically wide enough to cover both light sources 46, 46a and sensors 48, 48a of the two arrangements 42, 42a. However, the filter 52 only covers the sensors 48, 48a and does not cover the light sources 46 and 46a.

It is to be appreciated that the first and fourth sensing arrangements 24, 42a are positioned to face each other so that light generated in one sensing arrangement can be sensed as florescence transmitted through the banknote in the other sensing arrangement. Clearly, reflected fluoresced light can be detected by the sensor in the same sensing arrangement that generates the non-visible light. In this way, reflected/transmitted sensed light-readings can be taken in either direction from either one of the upper or lower parts 12, 14 of the validator housing 10. The same is true of the second and third sensing arrangements 24a, 42 that are also aligned together.

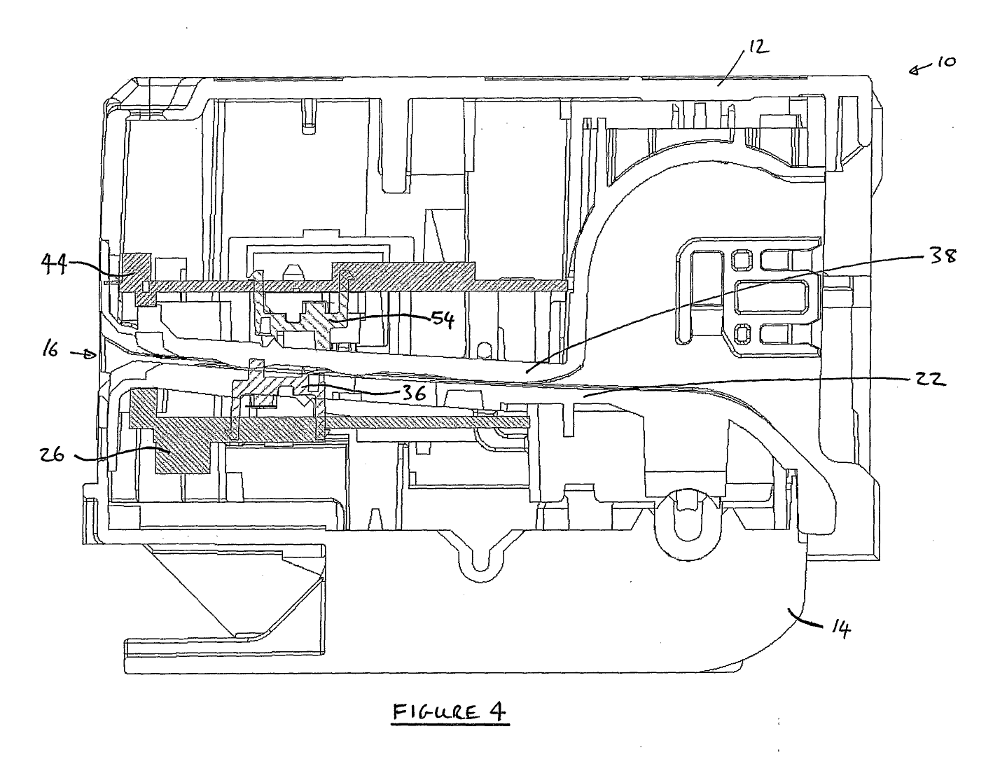

FIG. 4 is a cross-section through the validator housing 10 with its upper and lower parts connected. This figure shows how the first and second sensor arrangements 24, 24a are aligned with the third and fourth sensor arrangements 42, 42a to enable reflected and transmitted fluorescence to be detected.

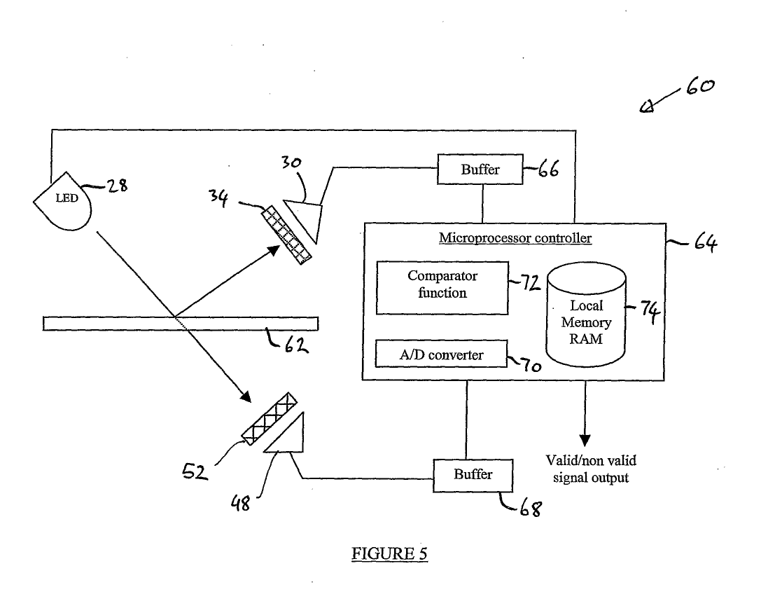

An electronic circuit which processes the output of the sensor arrangements 24, 24a, 42, 42a is now described with reference to FIG. 5. For the sake of brevity, only the processing in relation to the first and third aligned sensor arrangements 24, 42, is described herein. However, the following also applies to the second and fourth aligned sensor arrangements 24a, 42a, which are simply incorporated as extra inputs into the circuit described below.

The electronic circuit 60 whilst not shown in FIGS. 3a and 3b, is provided on the printed circuit boards 26, 44. The LED 28, filters 34, 52 and sensors 30, 48 are all directed to a banknote substrate 62 which is being analysed. Sensor 30 detects reflected fluoresced visible light whereas sensor 48 detects transmitted fluoresced visible light. The outputs of the sensors 30, 48 are sent to a microprocessor 64 via respective buffers 66, 68, which act to stabilise the analogue signal being generated by the sensors. The microprocessor controller (microcontroller) 64 is arranged to receive and process signals from the sensors 30, 48, to compare those signals with stored data and to determine whether the banknote 62 is acceptable. The controller 64 also controls the activation of the LED 28 when the banknote 62 is in the correct position for sensing.

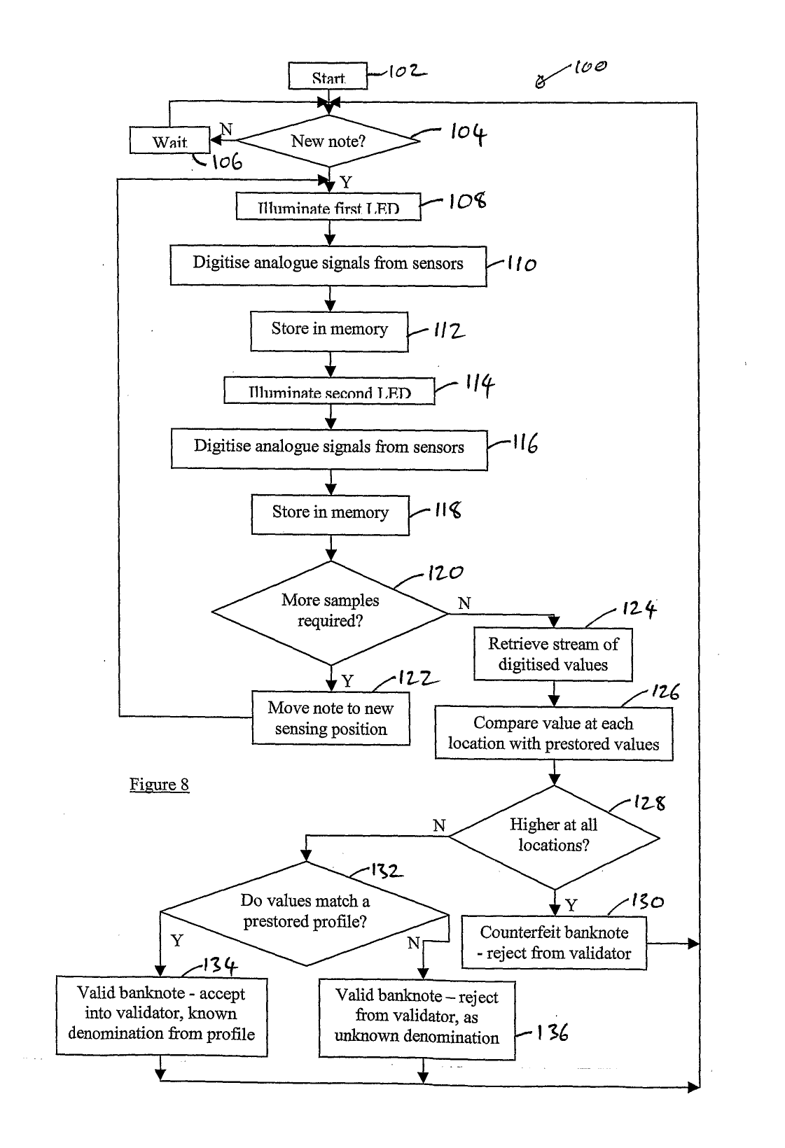

In order to perform the above, the microcontroller 64 is programmed to carry out particular functions. The first function is an analogue to digital (A/D) conversion function 70, which is used on incoming buffered signals from the sensors to generate a stream of digital values representing the analogue signal. The A/D function conversion results are stored in local memory 74: microprocessor RAM in this embodiment. A comparator function 72 is also provided in the microcontroller 64 for comparing the digitised sensor signals with a set of comparison values taken from the stored memory 74. This can conveniently be in the form of an algorithm that determines if the banknote is real or not and also what the value of the banknote 62 being sensed is. The algorithm is not described in the present application because those skilled in the art will be aware of many different algorithms to perform this function. However, the operation of the microcontroller 64 in controlling the LED 28 and the A/D function 70 to take samples from the banknote 62 is briefly described below and later with reference to FIG. 8.

Readings are taken at regular intervals and stored by the microprocessor 64. The number of readings depends on the length of the banknote, however, in this embodiment around 30 to 60 readings are taken, but this is not critical. It would be possible to make the present embodiment work with a continuous stream of data or pretty much any number of samples. This series of samples is compared to those expected from a valid note to determine firstly if it is a fake and secondly what value of note it is, as each valid note will have a certain characteristic fluorescence profile along its length. More specifically, if the banknote is counterfeit, the fluorescence output profile along the whole banknote 62 is probably relatively constant due to the blue fluorescence phenomenon, which would occur at every location. However, if output profile has specific ‘pulses’ at known positions along the length of the banknote then the banknote is likely to be genuine. This is because there is fluorescence at different wavelengths in the visible spectrum for different parts of a valid banknote, which is detected to make up a unique profile for the valid banknote 62. By using a broadband sensor, the generated signal integrates all of the sensed visible wavelengths of fluoresced light and so it is not known exactly what wavelength was being fluoresced. However, this is not important to the present embodiment as so long as both blue wavelength emissions (for counterfeit banknotes) and other visible wavelength emissions (for genuine banknotes) can be detected by the same sensor. The strength of the blue fluorescence for a counterfeit banknote is far greater than the more subtle fluorescence generated by a genuine banknote and this also helps to distinguish between false and genuine banknotes.

It is to be appreciated that readings cannot be taken from both sides of the banknote 62 at the same time with the same sensor 30, 30a, 48, 48a. Rather, the microprocessor 64 has to control the circuitry such that only one LED 28, 28a, 46, 46a is on at a time so as not to confuse the sensed signals. Accordingly, the microprocessor 64 is arranged to quickly alternate illumination of each LED 28, 28a, 46, 46a and take the relevant readings from the sensors.

In this embodiment, the comparison function 72 is activated once all of the readings from the sensors have been taken in order to simplify the whole comparison procedure 72. However, in alternative embodiments, processing on the stored readings can commence before all of the readings have been stored, which is more complex a process but a quicker one.

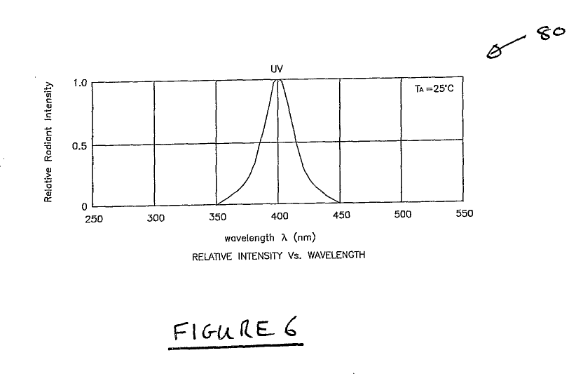

In order to appreciate how the present embodiment implements the present invention is it important to consider the characteristics of the LEDs 28, 28a, 46, 46a and the sensors 30, 30a, 48, 48a. FIG. 6 shows the output characteristics 60 of a Kingbright KP-2012-UVC LED device which is used for all of the LEDs 28, 28a, 46, 46a. The irradiating non-visible light is selected to have a wavelength between 100 nm and 400 nm in this embodiment, as this is the UV band. It is important that there is no light emitted at a longer wavelength (higher wavelength) than the cut-off wavelength of the filter; otherwise this would get through to the sensor. This effectively cuts out any light that does not cause the banknote to fluoresce. Accordingly, as the wavelength of the LEDs peaks at 400 nm and has a relative intensity of zero at 450 nm, a filter material having a −3 dB cut-off point characteristic at 450 nm is selected for use. This is considered to be the closest frequency to the visible spectrum at which non-visible light could possibly be irradiated from the LED. In another embodiment a filter material having a −3 dB cut-off point characteristic at 500 nm can be selected for use as it is 50 nm closer to the visible light spectrum than the highest possible wavelength emitted from the LED.

It is to be appreciated that longer wavelength UV LEDs are the least expensive devices so UV LEDs having a peak output in the range 380 nm-400 nm (right at the top of the band) are used. This is purely for economy, using shorter wavelengths may reveal more security features in the future, but these emitters are not cost effective at the moment.

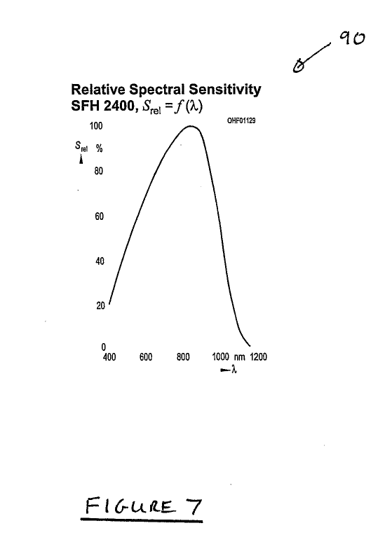

Referring now to FIG. 7, the relative spectral sensitivity characteristics 90 of the OSRAM SFH 2400 photodiode is shown. The photodiodes 30, 30a, 48, 48a of the present embodiment comprise this type of fairly common ordinary broadband photodiode. This type of diode is sensitive from 400 nm to 1100 nm in wavelength, which covers the whole of the visible spectrum (400 nm to 800 nm). It is only important that some of the light fluoresced from the banknote (not necessarily all of it) is sensed. It would be preferred that the sensor is sensitive to all visible light, but this is not essential. Accordingly, the broadband sensor can have a smaller range, which is big enough to pick up the ‘blue’ fluorescence of counterfeit banknotes as well as the fluorescence of genuine banknotes that occurs at other wavelengths in the visible spectrum.

Wide bandwidth devices are inexpensive, and a large bandwidth does not cause a problem in the present embodiment because a high-pass (wavelength) filter is used to limit the bandwidth. It is important to remember that the filters are selected and positioned such that none of the light from the LEDs 28, 28a, 46, 46a get to the sensors 30, 30a, 48, 48a.

A general method 100 of operation of the sensing arrangement and circuit of FIG. 5 is now described with reference to FIG. 8. The method starts at Step 102 with initialisation, of the banknote validator, namely loading of programs into the microprocessor memory for effecting the correct banknote validation. In this regard, different world currencies may have very different sensed characteristics and so the appropriate set of values has to be loaded into the validator.

The method 100 continues with the sensing of the insertion of a new banknote 62 at Step 104. If no new banknote 62 has been inserted, the validator goes into a wait and retry-loop 106. Otherwise, the first UV LED 28, 28a is illuminated at Step 108 to cause fluorescence in the banknote 62. The fluoresced visible light is filtered and sensed to generate an analogue signal, which is then digitised at Step 110 at the microcontroller 64. The digitised fluorescence value is then stored at Step 112 in memory 74. Subsequently, a second UV LED 46, 46a is energised at Step 114 to generate fluoresced visible light from the banknote 62 being validated. An analogue signal generated by filtered and sensed light is then digitised at Step 116 by the A/D converter function 70 at the microprocessor 64 and stored at Step 118 as a value for that banknote location.

Having completed the testing of the current location, the method determines whether there are any more banknote locations to be tested at Step 120 and if there are, the microprocessor instructs the banknote validator to advance the banknote at Step 122 to the next sensing position (this is done by means of controlling the drive mechanism (not shown) which is an inherent part of the banknote validator). Then the steps 108 to 120 are repeated for the new position on the banknote surface.

Alternatively, if there are no more banknote locations to be sampled, then the data processing stage can commence. The data processing stage starts with retrieval of the at Step 124 stream of stored digitised values from the local memory 74. The comparator function 72 of the microprocessor 64 then compares at Step 126 the measured values against prestored values from the memory 74. These prestored values represent fluoresced visible light profiles along the length of valid banknotes. If the comparison results in each of the sensed values being constant and higher than the profiles as determined at Step 128, then the banknote is likely to be counterfeit and it is rejected by being ejected from the validator. Alternatively, if the sensed values are not constant and all higher than the profile values, then a check is made at Step 132 to determine if any match the prestored profile values. If the stream of sensed values matches a profile (within tolerance limits) then the banknote is considered to be valid. The banknote is accepted at Step 134 and the matching profile determines the value of the banknote.

However, if the stream of sensed values do not match a stored profile, then the banknote is still valid, but is not recognised as being of a particular amount. In this case the banknote can either be accepted into the validator or rejected because the amount of the banknote, its value, cannot be ascertained.

Having described a first embodiment of the present invention, a second embodiment of the present invention is now described. The second embodiment is very similar to the first embodiment and accordingly, only the differences will be described hereinafter.

The main difference is that the LED light source is a near infrared light emitter rather than an ultraviolet light emitter. This change in irradiation wavelength employs the present invention at the other end of the visible spectrum to determine the validity of the banknote. Again this is based on the fact that the present inventor has determined that using infrared irradiation, real and false banknotes can have different characteristics of fluoresced light in the visible light spectrum. At present, the paper substrate used for known banknotes is not designed to have any special characteristics when illuminated under near infrared light. However, it is readily possible for banknote manufacturers to design or select a paper substrate for the banknote to have such a fluorescence characteristic and accordingly, the second embodiment could be used to distinguish such genuine banknotes from forgeries. The current second embodiment has been tested against certain paper substrates to prove the occurrence of the effect.

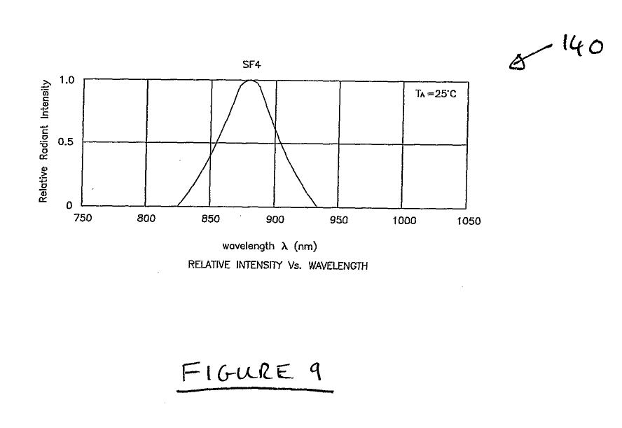

In the present embodiment, the near infrared LED has an output characteristic 140 shown in FIG. 9. As can be seen, the vast majority of energy of the emitted infrared radiation (non-visible light) is within the range 825 nm to 930 nm.

The banknote validator also comprises a low-wavelength pass (high-frequency pass) optical filter as opposed to a high-wavelength pass (low-frequency pass) optical filter. The filter has a −3 dB cut off point at 825 nm. This is considered to be the closest frequency to the visible spectrum at which non-visible light could possibly be irradiated from the LED.

In another embodiment a filter material having a −3 dB cut-off point characteristic at 775 nm can be selected for use as it is 50 nm closer to the visible light spectrum than the lowest possible wavelength emitted from the infrared LED.

It is to be appreciated that the present embodiments can be varied in many ways whilst still implementing the present invention. For example, even though the present embodiments describe measuring the banknote in a plurality of locations along its length and width and then comparing these readings to stored profiles, this amount of comparison is not necessary. Rather, the present invention can work with a single sensor arrangement and also with comparison at a single location if required. The principle works even at this crude level. More sensors and locations are provided to make the validator more robust against different types of fraud, but these are not essential.

Even though cost is a major issue in the present invention, having reduced the cost and complexity of verifying at a single location the validity of a banknote, the number of sensors can be increased for other applications. For example, if multiple receivers were provided that were physically separate, then these could be sampled all at the same time to provide quicker results albeit at a cost.

Having described a preferred embodiment of the present invention, it is to be appreciated that the embodiment in question is exemplary only, and that variations and modifications, such as those which will occur to those possessed of the appropriate knowledge and skills, may be made without departure from the spirit and scope of the invention as set forth in the appended claims. For example, it is also possible in an alternative embodiment, for the microcontroller functions of digitising the analogue sensor signals and comparing them to values stored within the RAM of the computer to be replaced by discrete components performing these functions. For example, discrete A/D converters could be used together with a comparator and a separate memory store. However, these discrete components would likely increase the cost of the circuitry, which is undesirable, as well as reduce its reliability and robustness.

Also in theory it would be possible to build a totally analogue validator (without A/D converters being required. However, this would be very expensive and not very flexible as it would not be able to be programmed differently.

1. A banknote validator arranged to discriminate between real and false banknotes, the validator comprising:
a light source arranged to emit light in the non-visible spectrum onto a banknote being validated, the emitted light including an ultraviolet (10 nm to 400 nm) or infrared (800 nm-100000 nm) wavelength of light;
a broadband light sensor arranged to sense a relatively broad band of visible light wavelengths of light emitted by fluorescence from the banknote in response to the banknote being irradiated with the non-visible wavelengths of light; and
an optical filter positioned between the banknote and the sensor and arranged to prevent illumination of the sensor with reflected or transmitted non-fluoresced light from the light source, the optical filter having a selected −3 db cut-off point which at least filters the non-visible light emitted from the light source, having a wavelength closest to the visible light spectrum wavelengths of light.

2. A validator according to claim 1, wherein the light source is arranged to emit light in the near non-visible spectrum.

3. A validator according to claim 1, wherein the light source comprises a single light source.

4. A validator according to claim 1, wherein the light source comprises a light emitting diode.

5. A validator according to claim 1, wherein the broadband sensor is arranged to measure the reflected or transmitted fluoresced light across the visible light spectrum of 400 nm to 800 nm in wavelength.

6. A validator according to claim 1, wherein the broadband sensor is arranged to have a response characteristic wide enough to measure fluoresced light generated from a false banknote, the fluoresced light generated from a genuine banknote.

7. A validator according to claim 1, wherein the filter comprises a low-cost plastics material.

8. A validator according to claim 1, wherein the filter has a −3 db cut off point of 50 nm closer to the visible spectrum than the closest wavelength of non-visible light emitted from the light source.

9. A validator according to claim 1, further comprising a comparator for comparing the value of the output signal of the sensor with predetermined data values that represent a valid banknote.

10. A validator according to claim 9, wherein the comparator is arranged to compare a plurality of output signal values from the sensor taken at different locations with a profile of predetermined data values representing a valid denomination of banknote.

11. A validator according to claim 9, further comprising a data store for storing the predetermined data values.

12. A validator according to claim 9, further comprising a determining means for determining the validity of the portion of the banknote based on the results of the comparator

13. A validator according to claim 12, wherein the determining means is arranged to determine the denomination of a valid banknote by matching the value of the output signal to the predetermined data values.

14. A validator according to claim 9, further comprising a microcontroller for controlling the operation of the light source and the comparator.

15. A validator according to claim 14, wherein the comparator comprises a function within the microcontroller.

16. A validator according to claim 14, wherein the determining means comprises a function within the microcontroller.

17. A validator according to claim 1, wherein the light source is arranged to emit ultraviolet (10 nm to 400 nm) wavelengths of light and the filter has a −3 db cut off point at a higher wavelength than the highest emitted wavelength of light.

18. A validator according to claim 17, wherein the light source is arranged to emit light in the near ultraviolet spectrum.

19. A validator according to claim 18, wherein the light source is arranged to emit ultraviolet light in the range of 380 to 400 nm and the filter has a −3 db cut off point at a wavelength greater than 400 nm.

20. A validator according to claim 17, wherein filter comprises a low frequency (high wavelength) pass filter.

21. A validator according to claim 1, wherein the light source comprises a light source emitting infrared (800 nm to 100000 nm) wavelengths of light and the filter has a −3 db cut off point at a lower wavelength than the lowest emitted wavelength of light.

22. A validator according to claim 21, wherein the light source is arranged to emit light in the near infrared spectrum.

23. A validator according to claim 21, wherein the filter comprises a high frequency (low wavelength) pass filter.

24. A validator according to claim 1 further comprising a plurality of said light sources, broadband sensors and optical filters and a controller arranged to control the illumination of each light source in rapid alternation such that, at any given time, any light sensor readings taken only reflect one possible light source illumination.

25. A banknote validation method of discriminating between real and false banknotes, the method comprising:
Irradiating light in the non-visible spectrum onto a banknote being validated, the emitted light including an ultraviolet (10 nm to 400 nm) or infrared (800 nm-100000 nm) wavelength of light;
optically filtering the light received from the banknote to obtain fluoresced light from the banknote, the optical filtering having a selected −3 db cut-off point which at least filters the non-visible light emitted from the light source, having a wavelength closest to the visible light spectrum wavelengths of light; and
measuring the filtered emitted light over a relatively wide range of visible light wavelengths in response to the banknote being irradiated with the non-visible wavelengths of light in use.

26. A method according to claim 25, further comprising:
comparing the value of the output signal of the sensor with predetermined values that represent a valid banknote;
determining the validity of the portion of the banknote based on the results of the comparison step.

27. A banknote validator arranged to discriminate between real and false banknotes, the banknote validator comprising:
a light source arranged to emit light in the non-visible spectrum onto a banknote being validated, the emitted light including an ultraviolet (10 nm to 400 nm) or infrared (800 nm-100000 nm) wavelength of light;
a broadband light sensor arranged to sense a relatively broad bank of visible light wavelengths of light emitted by fluorescence from the banknote in response to the banknote being irradiated with the non-visible wavelengths of light;
an optical filter positioned between the banknote and the sensor and arranged to prevent illumination of the sensor with reflected or transmitted non-fluoresced light from the light source, the optical filter having a selected −3 db cut-off point which at least filters the non-visible light emitted from the light source, having a wavelength closest to the visible light spectrum wavelengths of light;
a comparator for comparing the value of the output signal of the sensor with predetermined values that represent a valid banknote; and
a determining means for determining the validity of the portion of the banknote based on the results of the comparator.

28. A banknote validator arranged to discriminate between real and false banknotes, the banknote validator comprising:
a light source arranged to emit light in the non-visible spectrum onto a banknote being validated, the emitted light including an ultraviolet (10 nm to 400 nm) or infrared (800 nm-100000 nm) wavelength of light;
two broadband light sensors, one positioned in use with respect to the portion of the banknote to measure the filtered reflected light and the other sensor positioned in use with respect to the portion of the banknote to measure the filtered transmitted light, each sensor being arranged to be sensitive over a relatively broad band of visible wavelengths of light emitted by fluorescence from the banknote in response to the banknote being irradiated with the non-visible wavelengths of light and to generate an output signal representative of the measured light;
two high pass filters, each high-pass filter being arranged to have a −3 db point at least closer to the visible light spectrum than the closest wavelength of light radiated from the irradiating means, one of the filters being positioned to filter the light reflected from the portion of the banknote and other filter being positioned to filter the light transmitted through the portion of the banknote;
a comparator for comparing the value of the output signal of each sensor with predetermined values that represent a valid banknote; and
a determining means for determining the validity of the portion of the banknote based on the results of the comparator.
